(19) United States
(12) Patent Application Publication
(10) Pub. No.: US 2021/0405439 A1
(43) Pub. Date: Dec. 30, 2021

(54) LIGHT SOURCE UNIT, DISPLAY DEVICE, AND FILM

(71) Applicant: Toray Industries, Inc., Tokyo (JP)

(72) Inventors: Yuji Matsuo, Otsu-shi, Shiga (JP); Takayuki Uto, Otsu-shi, Shiga (JP); Miyu Shiraishi, Otsu-shi, Shiga (JP)

(73) Assignee: Toray Industries, Inc., Tokyo (JP)

(21) Appl. No.: 17/294,067

(22) PCT Filed: Dec. 4, 2019
(86) PCT No.: PCT/JP2019/047418

§ 371 Date: May 14, 2021

(30) Foreign Application Priority Data
Dec. 12, 2018 (JP) 2018-232194
Aug. 29, 2019 (JP) 2019-156653

(51) Int. Cl. G02F 1/1335

(52) U.S. Cl. CPC G02F 1/133507; G02F 1/133536; G02F 1/133555

(57) ABSTRACT

Provided are a light source unit, a display device, and a film. The light source unit has a light source and a film, the light source has a light-emitting band in the 450-650 nm wavelength range, the film has a mean transmittance of 70% or higher for light in the 450-650 nm wavelength range from the light source and incident at an angle of 0° to the normal to the film surface, the film satisfies the relationship Rp20≤Rp40<Rp70 with Rp70 being 30% or greater when Rp20, Rp40, and Rp70 represent the mean reflectance (%) for P waves in the 450-650 nm wavelength range for light from the light source incident at angles of 20°, 40°, and 70° to the normal to the film surface, and the light source and the film satisfy specific relationships.

Lb(0°)/La(0°)≥0.8 (1)

Lb(70°)/La(70°)<1.0 (2)

### CROSS REFERENCE TO RELATED APPLICATIONS

This is the U.S. National Phase application of PCT/JP2019/047418, filed Dec. 4, 2019, which claims priority to Japanese Patent Application No. 2018-232194, filed Dec. 12, 2018 and Japanese Patent Application No. 2019-156653, filed Aug. 29, 2019, the disclosures of each of these applications being incorporated herein by reference in their entireties for all purposes.

### FIELD OF THE INVENTION

The present invention relates to a light source unit, a display device, and a film.

### BACKGROUND OF THE INVENTION

Various light sources used in display devices such as liquid crystal displays include the surface light source device, which contains at least one light source and emits beams after radiating them planarly. There are different types of surface light source devices including an edge type one that contains at least a light source and a light guide plate designed to radiate the beams therefrom planarly and a direct type one that contains a light source and emits light in a direction opposed to the light source. A common display device emits light in an angle range of about ±45° around the frontward direction of 0°, which is defined as visible range, and the beams emitted at angles outside this range will be a loss. Compared with this, in the case of an edge type surface light source device, the beams emitted from a light guide plate will diffuse in an uncontrolled manner and therefore, the intensity of the beams emitted from the light guide plate is generally at a maximum in an oblique direction rather than in the frontward direction. This occurs because the beams coming from the light source and entering the edge of the light guide plate are reflected in oblique directions as they radiate planarly, and therefore tend to exit in oblique directions rather than in the frontward direction. Conventionally, a plurality of light diffusing sheets, prism sheets, etc., are provided near the emitting surface of the light guide plate so that the beams emitting in oblique directions from the light guide plate are condensed in the frontward direction to increase the front luminance (Patent document 1 and Patent document 2). In the case of a direct type surface light source device, in particular, a plurality of light sources are arranged to form a surface light source, and lenses etc. are used so that the beams coming from the light sources are radiated not only in the frontward direction but also in oblique directions to reduce the unevenness of light distribution among the light sources. In addition, the unevenness is eliminated by passing the beams through a diffusing sheet etc., and a plurality of light diffusing sheets, prism sheets, etc., are provided so that the beams are condensed in the frontward direction to increase the front luminance.

### PATENT DOCUMENTS

Patent document 1: Japanese Unexamined Patent Publication (Kokai) No. 2015-180949
Patent document 2: Japanese Unexamined Patent Publication (Kokai) No. 2015-87774

### SUMMARY OF THE INVENTION

However, because of their structures, diffusing sheets and prism sheets cannot serve to condense all beams coming from shallow angles, and therefore, it is difficult, even when using diffusing sheets, prism sheets, etc., for all beams emitted in oblique directions from an edge type light guide plate or from a direct type diffusing sheet to be condensed in the frontward direction.

FIG. 4, which shows part of a cross section of a light guide plate, gives a schematic diagram that illustrates a conventional surface light source incorporating a light guide plate. The light guide plate has a light emitting surface 4 and an opposite surface 5 to the light emitting surface of the light guide plate, and the light emitting surface of the light guide plate is exposed to a medium that is assumed to be air as an example. Two beams, 6a and 7a, are reflected and radiated above the plane in oblique directions in the light guide plate, wherein the beam 6a has a smaller incidence angle to the light emitting surface 4 whereas the beam 7a has a larger incidence angle to the light emitting surface 4. When reaching the light emitting surface 4, part of the beam 6a is reflected depending on the reflectance to give a reflected beam 6b, which goes back into the light guide plate while the remaining portion, i.e. the beam 6c, is emitted out of the light guide plate. Subsequently, the beam 6b is reflected by the opposite surface 5 to the light emitting surface of the light guide plate. Of the reflected beams, the beam 6d is the specular reflection component while the beams 8 are diffuse reflection components that travel in the frontward direction. Compared to this, the beam 7a, which has a large incidence angle to the light emitting surface 4, is totally reflected by the light emitting surface 4, and the reflected beam 7b is then reflected by the opposite surface 5 to the light emitting surface of the light guide plate. Of the reflected beams, the beam 7d is the specular reflection component while the beams 9 are diffuse reflection components that travel in the frontward direction. In this way, the internal beams in the light guide plate are reflected in oblique directions while radiating above the plane, and some of them such as the beams 6c, 8, and 9 are emitted out of the light guide plate to give outgoing light above the plane. However, some beams (such as the beam 6a) have smaller incidence angles to the light emitting surface 4 than the beam 7a, and when reaching the light emitting surface 4, they give oblique outgoing beams (such as the beam 6c) outside the light guide plate.

In this method, therefore, beams are emitted not only in the frontward direction, but also in oblique directions, out of the light guide plate, leading to the problem of a decreased light intensity in the frontward direction. To solve this problem, the conventional method uses diffusing sheets, prism sheets, etc., provided on the light emitting surface of the light guide plate so that the directions of the oblique beams emitted out of the light guide plate are shifted toward the frontward direction. However, because of their structures, diffusing sheets, prism sheets, etc., cannot serve to condense all beams coming from shallow angles (beams having small incidence angles), and therefore, it is impossible, even when using diffusing sheets, prism sheets, etc., for all beams emitted in oblique directions from the light guide plate to be condensed in the frontward direction.

The main object of the present invention is to solve the aforementioned problem. More specifically, it aims to provide a light source unit, a display device, and a film that serve to condense beams strongly and increase the front luminance as compared with the conventional ones.

To solve the problem as described above, the present invention in exemplary embodiments is configured as described below. Specifically, it provides a light source unit including a light source and a film wherein the light source has an emission band in the wavelength range of 450 nm to 650 nm; the film has an average transmittance of 70% or more for incident beams in the wavelength range of 450 nm to 650 nm coming from the light source at an angle of 0° to the normal to the film plane; the P-waves of incident beams coming from the light source at an angle of 20°, 40°, or 70° to the normal to the film plane satisfy the relation of Rp20≤Rp40<Rp70 where Rp20, Rp40, and Rp70 represent their average reflectance (%) over the wavelength range of 450 nm to 650 nm, with Rp70 being 30% or more; and the relations represented by the following formula (1) and (2) are satisfied where La(0°) is the luminance of an incident beam coming from the light source at an angle of 0° to the normal to the film plane, La(70°) is the luminance of an incident beam at an angle of 70° to the normal to the film plane, Lb(0°) is the luminance of a beam emitted from the film at an angle of 0° to the normal to the film plane after coming from the light source and entering the film, and Lb(70°) is the luminance of a beam emitted from the film at an angle of 70° to the normal to the film plane:

Lb(0°)/La(0°)≥0.8 (1)

Lb(70°)/La(70°)<1.0 (2)

The present invention can provide a light source unit, a display device, and a film that serve to condense beams strongly and increase the front luminance as compared with the conventional ones.

### BRIEF DESCRIPTION OF DRAWINGS

FIG. 1 A schematic diagram showing the angle dependence of the reflectance of a conventional transparent film for the P-wave and the S-wave.

FIG. 2 A schematic diagram showing the angle dependence of the reflectance of a conventional reflection film for the P-wave and the S-wave.

FIG. 3 A schematic diagram showing the angle dependence of the reflectance of the film according to embodiments of the present invention for the P-wave and the S-wave.

FIG. 4 A schematic diagram illustrating the conventional method for producing a surface light source using a light guide plate.

FIG. 5 A schematic diagram illustrating the effect of the film according to embodiments of the present invention provided on the beam emitting surface of a light guide plate.

FIG. 6 A front view of the light source unit according to embodiments of the present invention.

### DETAILED DESCRIPTION OF EMBODIMENTS OF THE INVENTION

The inventors found that beams emitted from an edge type light guide plate or a direct type diffusing sheet can be condensed in the frontward direction and increase the front luminance by using a light source unit including a light source and a film wherein the light source has an emission band in the wavelength range of 450 nm to 650 nm; the film has an average transmittance of 70% or more for incident beams in the wavelength range of 450 nm to 650 nm coming from the light source at an angle of 0° to the normal to the film plane; the P-waves of incident beams coming from the light source at an angle of 20°, 40°, or 70° to the normal to the film plane satisfy the relation of Rp20≤Rp40<Rp70 where Rp20, Rp40, and Rp70 represent their average reflectance (%) over the wavelength range of 450 nm to 650 nm, with Rp70 being 30% or more; and the relations represented by the following formula (1) and (2) are satisfied where La(0°) is the luminance of an incident beam coming from the light source at an angle of 0° to the normal to the film plane, La(70°) is the luminance of an incident beam at an angle of 70° to the normal to the film plane, Lb(0°) is the luminance of a beam emitted from the film at an angle of 0° to the normal to the film plane after coming from the light source and entering the film, and Lb(70°) is the luminance of a beam emitted from the film at an angle of 70° to the normal to the film plane:

Lb(0°)/La(0°)≥0.8 (1)

Lb(70°)/La(70°)<1.0 (2).

This is described in more detail below. In the case of where an electromagnetic wave (light) is incident on an object from an oblique direction, the P-wave means the electromagnetic wave in which the electric field component is parallel to the incidence plane (linearly polarized light vibrating in the parallel direction to the incidence plane) and the S-wave means the electromagnetic wave in which the electric field component is perpendicular to the incidence plane (linearly polarized light vibrating in the perpendicular direction to the incidence plane).

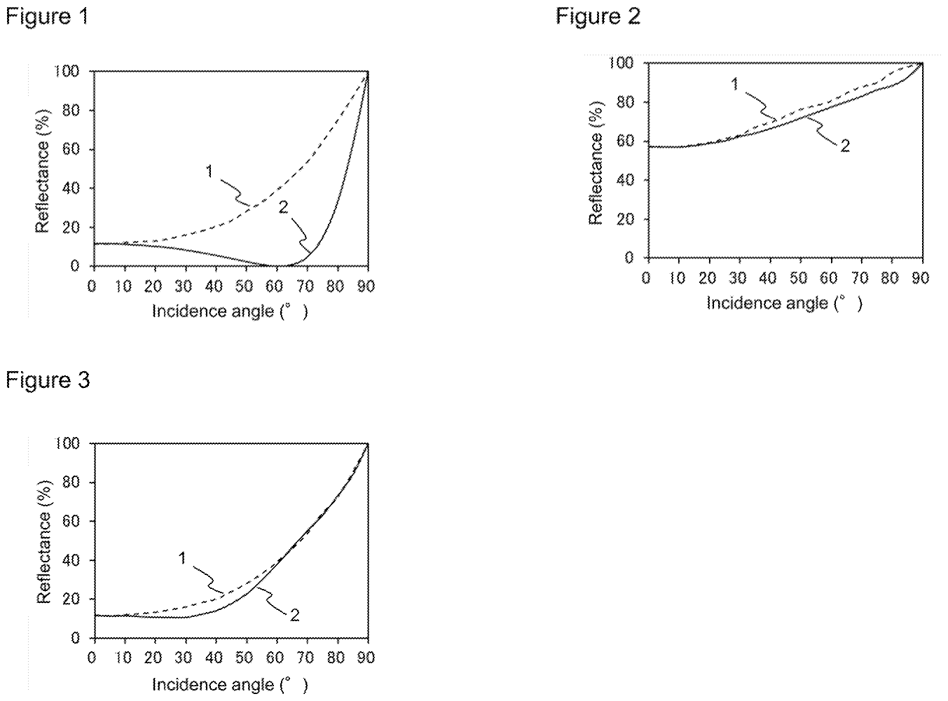

Reflection characteristics of the P-wave and the S-wave described below. FIGS. 1, 2, and 3 show the angle dependence of reflectance of a P-wave and an S-wave with a wavelength of 550 nm in the case where a beam traveling through air enters a conventional transparent film, a conventional reflection film, and the film according to embodiments of the present invention, respectively. Here, examples for beams with a wavelength of 550 nm are shown, but a relation as illustrated in FIGS. 1 to 3 are satisfied at any other wavelength.

According to the Fresnel equations, the reflectance of the P-wave at the surface of a conventional transparent film decreases with an increasing incidence angle and subsequently the reflectance tends to start increasing after reaching a reflectance of 0%. The reflectance of the S-wave increases with an increasing incidence angle. In the case of a conventional reflection film, both the P-wave and the S-wave have some reflectance (i.e., low in transmittance) at an incidence angle of 0° as shown in FIG. 2, and then, for both the P-wave and the S-wave, the reflectance increases with an increasing incidence angle. In the case of the film according to embodiments of the present invention, on the other hand, both the P-wave and the S-wave are low in reflectance (i.e., high in transmittance) at an incidence angle of 0°, and then, both the P-wave and the S-wave increase in reflectance with an increasing incidence angle. This difference in the dependence of reflectance on incidence angle between the conventional reflection film and the film according to embodiments of the present invention is attributable to the difference in design in terms of the difference in the refractive index in the parallel direction to the film plane (in-plane refractive index difference) between the two kinds of layers stacked alternately and the difference in the refractive index in the perpendicular direction to the film plane (through-plane refractive index difference) between them. Specifically, the conventional reflection film is designed so that light is reflected efficiently due to an increased in-plane refractive index difference and through-plane refractive index difference between the two kinds of layers stacked alternately. Accordingly, both the P-wave and the S-wave have some reflectance at an incidence angle of 0° and both the P-wave and the S-wave increase in reflectance with an increasing incidence angle.

In the case of the film according to embodiments of the present invention, on the other hand, the in-plane refractive index difference is small and the through-plane refractive index difference is large between the two kinds of layers stacked alternately in order to transmit beams in the frontward direction while only reflecting beams in oblique directions. Accordingly, both the P-wave and the S-wave are low in reflectance (i.e., high in transmittance) at an incidence angle of 0° due to a small in-plane refractive index difference between the two kinds of layers stacked alternately, and both the P-wave and the S-wave increase in reflectance with an increasing incidence angle due to an increase in the through-plane refractive index difference between the two kinds of layers stacked alternately.

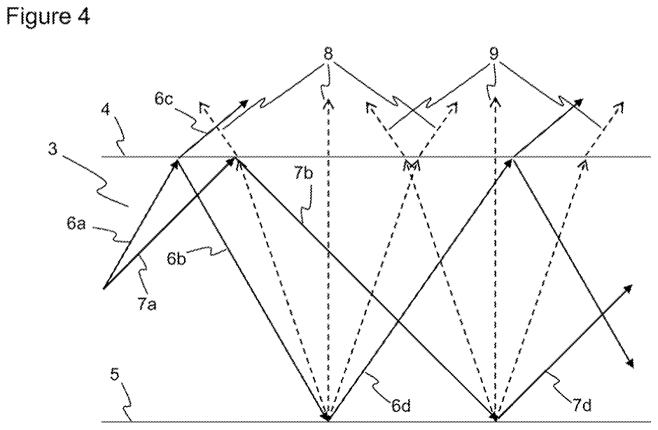

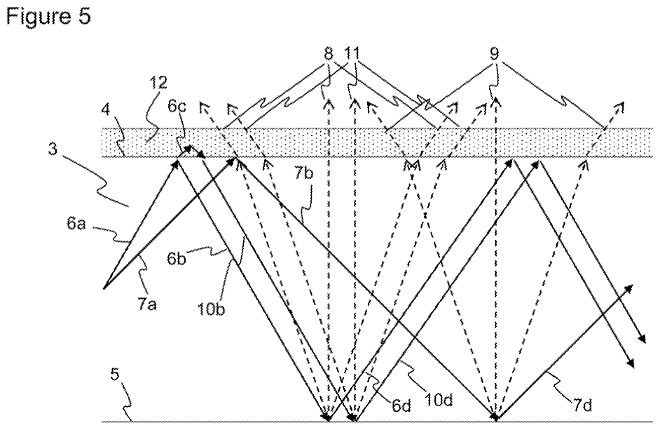

FIG. 5 gives a schematic diagram of a light guide plate having thereon the film according to embodiments of the present invention, which is intended to illustrate the effect of the film according to embodiments of the present invention formed on the light emitting surface of a light guide plate. The beam 6a has a smaller incidence angle to the light emitting surface 4. In the conventional method, therefore, it is mostly emitted as the beam 6c out of the light guide plate as seen in FIG. 4, but if there exists the film according to embodiments of the present invention, which is high in reflectance for beams in oblique directions, the beam 6c is reflected back into the light guide plate by the film according to embodiments of the present invention that covers the light emitting surface of the light guide plate. As a result of this, the outgoing beams from the light guide plate are condensed in the frontward direction to ensure a higher luminance as compared to the conventional method. After being reflected by the film according to embodiments of the present invention and the light emitting surface of the light guide plate, the beams 6b, 7b, and 10b are reflected by the light emitting surface 5 of the light guide plate. Of the reflected beams, the beams 6d, 7d, and 10d are specular reflection components while the beams 8, 9, and 11 are diffuse reflection components that travel in the frontward direction. Since the film according to embodiments of the present invention is high in transmittance for beams in the frontward direction, the beams 8, 9, and 11 are transmitted almost completely without undergoing reflection. If the film according to embodiments of the present invention is used to cover the light emitting surface of the light guide plate, therefore, those beams emitted in the frontward direction from the light guide plate will become outgoing beams such as the beams 8, 9, and 11. Thus, beams emitted out of the light guide plate can be condensed more efficiently in the frontward direction to increase the luminance as compared with the conventional method.

It is noted here that the structure of the light guide plate and the traveling directions of beams in the light guide plate described above are mere examples intended to explain the effects of the film according to embodiments of the present invention and that, even in the case of a structure of a light guide plate or traveling directions of beams in a light guide plate that are different from those described above, the film will have the function of condensing outgoing beams from the light guide plate in the frontward direction as long as it agrees with the concept that the film works to reflect beams emitted in oblique directions from the light guide plate back into the light guide plate while transmitting beams emitted in the frontward direction from the light guide plate. For example, although the opposite surface 5 to the light emitting surface of the light guide plate is a flat surface in the above description, it may be a rough surface or have irregularities. Furthermore, the film according to the present invention is not necessarily in direct contact with the light guide plate, but one or a plurality of sheets such as diffusing sheet may be provided between the light guide plate and the film according to embodiments of the present invention.

Furthermore, not only in a surface light source device using a light guide plate, but also in a direct type one containing a light source and emitting light in a direction opposed to the light source, the use of the film according to embodiments of the present invention can have the aforementioned effect so that beams that would be emitted in oblique directions in a conventional device are condensed in the frontward direction. Thus, the emitted beams can be converged in the frontward direction to increase the luminance.

The light source unit according to embodiments of the present invention is a light source unit having a light source and a film, wherein the light source is required to have an emission band in the wavelength range of 450 nm to 650 nm. To determine the emission band for the present invention, an emission spectrum of the light source is measured to identify the wavelength at which a maximum intensity occurs in the emission spectrum, which is referred to as the emission peak wavelength of the light source, and the wavelength range defined by the shortest wavelength and the longest wavelength where the emission intensity is 5% or more of that at the emission peak wavelength of the light source is adopted.

The light source unit according to embodiments of the present invention satisfies the relations represented by the following formulae (1) and (2) where La(0°) is the luminance of an incident beam coming from the light source at an angle of 0° to the normal to the film plane, La(70°) is the luminance of an incident beam at an angle of 70° to the normal to the film plane, Lb(0°) is the luminance of a beam emitted from the film at an angle of 0° to the normal to the film plane after coming from the light source and entering the film, and Lb(70°) is the luminance of a beam emitted from the film at an angle of 70° to the normal to the film plane:

Lb(0°)/La(0°)≥0.8 (1)

Lb(70°)/La(70°)<1.0 (2).

The Lb(0°)/La(0°) ratio calculated by the formula (1) represents the luminance retention rate (or luminance improvement rate) in the frontward direction, and it increases with an increasing luminance retention rate (or luminance improvement rate) in the frontward direction. If Lb(0°)/La(0°)=1, it means that the outgoing beam has the same intensity as the beam coming from the light source and entering the film at an angle of 0° to the normal to the film plane, whereas if Lb(0°)/La(0°)>1, it means that the outgoing beam emitted at an angle of 0° to the normal to the film plane is higher in intensity than the beam coming from the light source and entering the film at an angle of 0° to the normal to the film plane. It is preferable for the Lb(0°)/La(0°) ratio to be more than 1.0, more preferably 1.1 or more, and still more preferably 1.2 or more.

The Lb(70°)/La(70°) ratio calculated by the formula (2) represents the transmittance for light incident in an oblique direction and a smaller value means that a less amount of light incident in an oblique direction can be transmitted. It is preferable for the Lb(70°)/La(70°) ratio to be less than 0.8, more preferably less than 0.7.

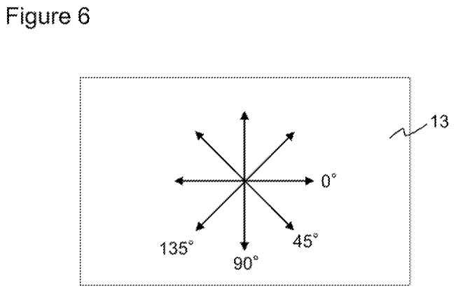

For the light source unit according to embodiments of the present invention, furthermore, the azimuthal variation in the Lb(70°)/La(70°) ratio is preferably 0.3 or less. Here, as shown in FIG. 6, the azimuthal variation means the difference between the maximum and minimum of the Lb(70°)/La(70°) ratio observed at azimuthal angles of 0°, 45°, 90°, and 135° measured from the length direction of the light source unit, which defines an azimuthal angle of 0°. Prism sheets are generally used as light condensing films, but since they have azimuthal unevenness in light condensing characteristics, a plurality thereof are used in a stack to reduce such unevenness, although this cannot serve for complete elimination of the unevenness. The film according to embodiments of the present invention is small in azimuthal unevenness and therefore, a single sheet thereof can have a satisfactory light condensing effect. It is preferably for the azimuthal variation in the Lb(70°)/La(70°) ratio to be 0.1 or less, more preferably 0.01 or less. A good method to decrease the azimuthal variation is, for example, to reduce the in-plane unevenness in refractive index of the film according to embodiments of the present invention, and the in-plane unevenness in refractive index of the film can be reduced by decreasing the difference in the orientation state between the film length direction and the width direction in the biaxial film stretching step.

As major embodiments, the present invention provides a light guide plate unit including the aforementioned film disposed on the light emitting surface of the light guide plate, a light source unit including such a light guide plate unit and a light source, a display device including such a light source unit, a light source unit including a substrate having a plurality of light sources and the aforementioned film disposed on the light emitting surface of the substrate, and a display device including such a light source unit. Examples of the display devices include a liquid crystal display device and an organic EL (electro-luminescence) display device.

The light source unit according to the present invention can have various structures such as one consisting of a reflection film, a light guide plate, a diffusing sheet, and a prism sheet stacked in this order and provided with a light source installed on the edge of the light guide plate so that beams can radiate above the plane to serve as a light source unit, and one consisting of a substrate having a plurality of light sources in combination with a reflection film, a diffusion plate, and a prism sheet stacked in this order on the light emitting side of the substrate to emit light in a direction opposed to the light source. The reflection film may a film that serves for diffusion reflection or specular reflection. Especially, a film serving effectively for diffusion reflection is preferred and a white reflection film is particularly preferred. A plurality of diffusion films and prism sheets may be used together, rather than using them singly. The light source may be a white light source, a red, blue, or green monochromatic light source, or a combination of two of these monochromatic light sources, which have an emission band of 450 nm to 650 nm. Regarding the emission mechanism, they include LED (light emitting diode), CCFL (cold cathode fluorescent lamp), or organic EL. Regarding the position relative to these light source unit members in a light source unit having a light guide plate, the film according to the present invention is preferably provided on the light emitting surface, rather than inside the light guide plate, and preferably located below a prism sheet. In the case of a light source unit having a light source and emitting light in a direction opposed to the light source, it is preferably provided on the light emitting surface, rather than inside the diffusion plate. Furthermore, the film may not only be provided with an air gap, but also be disposed by bonding to another member with a sticking agent, adhesive, etc.

As an example, a display device containing the light source unit according to the present invention may have a structure that consists of a diffusing sheet, a prism sheet, and a polarization reflection film stacked in this order, with the film according to embodiments of the present invention being disposed between the diffusing sheet and the polarization reflection film.

If this structure is adopted, the unevenness is eliminated by the diffusing sheet, and strong beams emitted in oblique directions are condensed in the frontward direction. Furthermore, iridescent color unevenness, which causes rainbow-like colors on display screens, can be reduced by providing a polarizing plate or a liquid crystal cell on the visible side of a polarization reflection film. In addition, other preferred embodiments include a display device having a structure consisting of a reflection film, a light guide plate, a diffusing sheet, a prism sheet, and a polarization reflection film stacked in this order, with the film according to embodiments of the present invention being disposed between the diffusing sheet and the polarization reflection film, and a display device having a structure consisting of a reflection film, a light source, a diffusing sheet, a prism sheet, and a polarization reflection film stacked in this order, with the film according to embodiments of the present invention being disposed between the diffusing sheet and the polarization reflection film.

As a structural example, the display device according to the present invention may be in the form of a display device having an infrared ray sensor. A display device having an infrared ray sensor can have the function of user authentication by recognizing a finger print, face, iris, etc., of a user by means of infrared rays. In addition, such an infrared ray sensor can have the function of operating the display device by detecting movements of fingers, hands, eyes, etc., of the operator. The display device member working as interface between the infrared ray sensor that receives infrared rays and the user to be authenticated preferably has a high parallel infrared light transmittance. It is preferable, therefore, that the film according to embodiments of the present invention has a maximum parallel light transmittance of 50% or more, more preferably 70% or more, still more preferably 80% or more, and particularly preferably 85% or more, for beams having a wavelength of 800 nm to 1,600 nm and an incidence angle of 0° to the normal to the film plane. A common infrared ray sensor can emit and receive beams in the wavelength range of 800 nm to 1,600 nm, and typically has a peak wavelength of 850 nm, 905 nm, 940 nm, 950 nm, 1,200 nm, 1,550 nm, etc. Typical light source units used in display devices provided with infrared ray sensors include one consisting of a reflection film, a light guide plate, a diffusing sheet, and the film according to embodiments of the present invention stacked in this order and provided with a light source installed on the edge of the light guide plate so that beams can radiate above the plane to serve as a light source unit, and one consisting of a substrate having a plurality of light sources in combination with a reflection film, a diffusion plate, and the film according to embodiments of the present invention stacked in this order on the light emitting side of the substrate to emit light in a direction opposed to the light source.

An additional prism sheet or a polarization reflection film may be combined with the above structures, but the display device member working as interface between the infrared ray sensor and the user to be authenticated preferably has a high parallel infrared light transmittance and a low infrared light scattering rate (infrared haze).

A prism sheet consists of a planar base and triangular convexities formed thereon (prisms) and serves to condense not only visible beams but also infrared rays. It condenses beams (visible beams and infrared rays) incident on the surface of the base whereas it diffuses beams (visible beams and infrared rays) incident on the surface on the prism side. In addition, it is high in reflectance for beams incident on the surface of the base at an incidence angle of 0°. Therefore, if infrared information pass through a prism sheet before being detected by an infrared ray sensor, the infrared information is disturbed as the ray undergoes condensation, diffusion, and reflection. Disturbance of infrared information leads to the problem of a decrease in the detection accuracy of the infrared ray sensor. The use of a prism sheet is not preferred when this phenomenon can occur.

Compared with this, the film according to embodiments of the present invention does not disturb infrared information because it is high not only in visible light transmittance but also for parallel infrared light transmittance when the light is incident at an angle of 0° to the normal to the film plane. When applied to a display device incorporating an infrared ray sensor, therefore, the film according to embodiments of the present invention serves to increase both the luminance and the infrared ray detection accuracy.

It is preferable, furthermore, for the display device according to the present invention to have a view angle control layer. In the display device, it is preferable for a view angle control layer to be located at a position closer to the light emitting surface than the film according to the present invention. As an example, the view angle control layer is preferably a liquid crystal layer, and the liquid crystal molecules in the liquid crystal layer preferably have the feature that their orientation shifts from an oblique direction to the horizontal direction or shifts from the horizontal direction to an oblique direction when electricity is applied to the liquid crystal molecules. In a liquid crystal layer having such orientation characteristics, the view angle is controlled in the frontward direction when the orientation in the liquid crystal layer is in an oblique direction whereas it is controlled at a large angle when the orientation in the liquid crystal layer is in the horizontal direction.

It is preferable for the film according to the present invention to be a three or more layered laminated film containing layers of a thermoplastic resin A (layers A) and layers of a thermoplastic resin B (layers B) different from the thermoplastic resin A that are stacked alternately. Here, in the expression “a thermoplastic resin B different from the thermoplastic resin A” means that they differ in terms of any of crystalline/amorphous property, optical property, and thermal property. Being different in terms of optical property means that their values of refractive index differ by 0.01 or more, and being different in terms of thermal property means that their melting points or glass transition temperatures differ by 1° C. or more. In addition, they are also deemed to be different in terms of thermal property when either resin has a melting point while the other resin does not have a melting point, or when either resin has a crystallization temperature while the other resin does not have a crystallization temperature. If thermoplastic resins having different characteristics are stacked, the resulting film can develop a function that cannot be realized by a single layer of either thermoplastic resin.

Useful thermoplastic resins that can serve for embodiments of the present invention include, for example, polyolefins such as polyethylene, polypropylene, and poly(4-methylpentene-1); cycloolefins such as alicyclic polyolefins prepared through ring opening metathesis polymerization or addition polymerization of norbornenes and copolymers prepared through addition polymerization thereof with other olefins; biodegradable polymers such as polylactic acid and polybutyl succinate; polyamides such as nylon 6, nylon 11, nylon 12, and nylon 66; polyesters such as aramid, polymethyl methacrylate, polyvinyl chloride, polyvinylidene chloride, polyvinyl alcohol, polyvinyl butyral, ethylene vinyl acetate copolymer, polyacetal, polyglycolic acid, polystyrene, styrene-copolymerized polymethyl methacrylate, polycarbonate, polypropylene terephthalate, polyethylene terephthalate, polybutylene terephthalate, and polyethylene-2,6-naphthalate; and others such as polyether sulfone, polyether ether ketone, modified polyphenylene ether, polyphenylene sulfide, polyether imide, polyimide, polyallylate, tetrafluoroethylene resin, trifluoroethylene resin, trifluoroethylene chloride resin, tetrafluoroethylene-hexafluoropropylene copolymer, and polyvinylidene fluoride. Of these, polyesters are particularly preferred from the viewpoint of strength, heat resistance, and transparency, and preferred polyesters include those produced by polymerization of monomers that contain aromatic dicarboxylic acid or aliphatic dicarboxylic acid and diols as main components.

Here, useful aromatic dicarboxylic acids include, for example, terephthalic acid, isophthalic acid, phthalic acid, 1,4-naphthalene dicarboxylic acid, 1,5-naphthalene dicarboxylic acid, 2,6-naphthalene dicarboxylic acid, 4,4′-diphenyl dicarboxylic acid, 4,4′-diphenyl ether dicarboxylic acid, and 4,4′-diphenylsulfone dicarboxylic acid. Useful aliphatic dicarboxylic acids include, for example, adipic acid, suberic acid, sebacic acid, dimer acid, dodecanedioic acid, cyclohexane dicarboxylic acid, and ester derivatives thereof. Of these, particularly preferred ones include terephthalic acid and 2,6-naphthalene dicarboxylic acid. These acid components may be used singly or two or more thereof may be used in combination, and they may be partly copolymerized with an oxyacid such as hydroxybenzoic acid.

On the other hand, useful diol components include, for example, ethylene glycol, 1,2-propanediol, 1,3-propanediol, neopentyl glycol, 1,3-butanediol, 1,4-butanediol, 1,5-pentanediol, 1,6-hexanediol, 1,2-cyclohexanedimethanol, 1,3-cyclohexanedimethanol, 1,4-cyclohexanedimethanol, diethylene glycol, triethylene glycol, polyalkylene glycol, 2,2-bis(4-hydroxyethoxyphenyl) propane, isosorbate, and spiroglycol. In particular, the use of ethylene glycol is preferred. These diol components may be used singly or two or more thereof may be used in combination.

Of the above polyesters, preferred ones include polyethylene terephthalate and copolymers thereof, polyethylene naphthalate and copolymers thereof, polybutylene terephthalate and copolymers thereof, polybutylene naphthalate and copolymers thereof, polyhexamethylene terephthalate and copolymers thereof, and polyhexamethylene naphthalate and copolymers thereof.

Furthermore, in the case where the film according to embodiments of the present invention has a multilayer laminated film structure as described above, it is preferable that the thermoplastic resins having different characteristics to be used in combination differ in glass transition temperature by an absolute value of 20° C. or less. If using resins differing in glass transition temperature by an absolute value of more than 20° C., inferior stretching can occur frequently during the production of a multilayer laminated film.

In the case where the film according to embodiments of the present invention has a multilayer laminated film structure as described above, it is particularly preferable that the thermoplastic resins having different characteristics to be used in combination differ in the sp value (also referred to as solubility parameter) by an absolute value of 1.0 or less. If the difference in the sp value by an absolute value of 1.0 or less, delamination will not occur easily. It is more preferable that the polymers having different characteristics to be used in combination have the same basic backbone. The basic backbone referred to above means the repeating unit that forms the resin.

For example, if polyethylene terephthalate is used as either of the thermoplastic resins, it is preferable for the other thermoplastic resin to contain ethylene terephthalate, i.e. the same backbone as in the polyethylene terephthalate, from the viewpoint of easy formation of a highly accurate laminated structure. If the resins having the same basic backbone are polyester resins having different optical characteristics, a highly accurate laminated structure can be formed and delamination will not occur easily at the interface between stacked layers.

The resins having the same basic backbone and having different characteristics are preferably copolymers. Specifically, for example, in the case where either of the resins is polyethylene terephthalate, the other resin contains the ethylene terephthalate unit and a repeating unit having a different ester bond. The proportion of such a different repeating unit (occasionally referred to as copolymerization rate) is preferably 5 mol % or more to develop different characteristics and, on the other hand, preferably 90 mol % or less to ensure good interlaminar contact as well as high thickness accuracy and thickness uniformity of the layers because of small difference in thermal flow characteristics. It is more preferably 10 mol % more and 80 mol % or less. For the layer A and the layer B, furthermore, it is also preferable to use a blend or alloy of a plurality of different type thermoplastic resins. The use of a blend or alloy of a plurality of different type thermoplastic resins serves to develop characteristics that cannot be realized by using a single thermoplastic resin.

In the case where the film according to embodiments of the present invention has a multilayer laminated film structure, it is preferable that the thermoplastic resin A and/or the thermoplastic resin B are polyesters and it is also preferable that the thermoplastic resin A incorporates, as main component, a polyester that contains polyethylene terephthalate while the thermoplastic resin B incorporates, as main component, a polyester that contains terephthalic acid as the dicarboxylic acid component and ethylene glycol as the diol component, or instead contains naphthalene dicarboxylic acid or cyclohexane dicarboxylic acid as the dicarboxylic acid component and at least one copolymerization component selected from cyclohexane dimethanol, spiroglycol, and isosorbide as the diol component. Here, the main component of the thermoplastic resin A means the component that accounts for 70 wt % or more of all resins present in the layer A. In addition, the main component of the thermoplastic resin B means the component that accounts for 35 wt % or more of all resins present in the layer B.

It is necessary that the film according to embodiments of the present invention has an average transmittance of 70% or more for incident beams in the wavelength range of 450 nm to 650 nm coming at an angle of 0° to the normal to the film plane and that the P-waves of incident beams coming at an angle of 20°, 40°, or 70° to the normal to the film plane satisfy the relation of Rp20≤Rp40<Rp70 where Rp20, Rp40, and Rp70 represent their average reflectance (%) over the wavelength range of 450 nm to 650 nm, with Rp70 being 30% or more. If a film having these characteristics are disposed on the light emitting surface of the light guide plate, this makes it possible for beams emitted out of the light guide plate to be condensed in the frontward direction to increase the luminance. It is more preferable for Rp70 to be 40% or more, still more preferably 50% or more, and particularly preferably 55% or more.

A typical constitution of the film according to embodiments of the present invention will be described below, but the invention should not be construed as being limited to the example.

The film according to the present invention is preferably a multilayer laminated film containing layers A and layers B stacked alternately, wherein the difference in in-plane refractive index between the layers A and the layers B is small and the difference in through-plane refractive index between the layers A and the layers B is large. Here, the difference in in-plane refractive index between the layers A and the layers B is preferably 0.03 or less, more preferably 0.02 or less, and still more preferably 0.01 or less. The difference in through-plane refractive index between the layers A and the layers B is preferably 0.03 or more, more preferably 0.06 or more, and still more preferably 0.09 or more. When the layers A and the layers B have such differences in in-plane refractive index and through-plane refractive index, they will have improved characteristics to allow beams traveling in the frontward direction to be transmitted instead of being reflected while allowing P-wave beams traveling in oblique directions to be reflected.

A good method to obtain layers A and layers B that have a small difference in in-plane refractive index and a large difference in through-plane refractive index is to use thermoplastic resins as the resin components of the layers A and the layers B, wherein the thermoplastic resin forming either type of layers (layers A) contains a crystalline polyester as main component whereas the thermoplastic resin forming the other type of layers (layers B) contains, as main component, either an amorphous polyester or a crystalline polyester having a melting point lower by 20° C. or more than that of the polyester of the layers A, with the difference in in-plane refractive index between the layers A and the layers B being 0.04 or less and the difference in glass transition temperature between the resins of the layers A and the layers B being 20° C. or less.

To realize a small difference in in-plane refractive index between the layers A and the layers B and a large difference in through-plane refractive index between them, it is important that either thermoplastic resin be oriented strongly in a parallel direction to the film plane (the refractive index in a parallel direction to the film plane is large while refractive index in the perpendicular direction to the film plane is small) whereas the other thermoplastic resin maintain isotropy (the refractive index in a parallel direction to the film plane is the same as that in the perpendicular direction). The use of a crystalline polyester as the thermoplastic resin forming the layers A serves to realize strong orientation in a parallel direction to the film plane, whereas the use of either an amorphous polyester or a crystalline polyester having a melting point lower by 20° C. or more than that of the polyester of the layers A as the thermoplastic resin forming the layers B serves to realize isotropy.

A preferred method to realize a small difference in in-plane refractive index between the layers A and the layers B and a large difference in through-plane refractive index between them is to form the layers A using a crystalline resin and then perform oriented crystallization of the layers Awhile forming the layers B using an amorphous resin having a high refractive index isotropically. In general, as a crystalline resin is oriented and crystallized increasingly, the refractive index in a parallel direction to the film plane (in-plane direction) increases while the refractive index in the perpendicular direction to the film plane (through-plane direction) decreases. In addition, if aromatic molecules having benzene rings, naphthalene rings, etc., are contained, both the refractive index in a parallel direction to the film plane (in-plane direction) and that in the perpendicular direction to the film plane (through-plane direction) increase. Accordingly, to form a multilayer laminated film containing different thermoplastic resins having a small difference in refractive index in a parallel direction to the film plane (in-plane direction), it is preferable that the thermoplastic resin used in the layers A is an oriented crystalline resin with a small aromatic content and that the amorphous resin used in the layers B is either an amorphous resin with a large aromatic content or a crystalline resin having a melting point lower by 20° C. or more than that of the oriented crystalline resin.

The glass transition temperature tends to increase with an increasing aromatic content, and in the case of the above resin combination, therefore, the glass transition temperature of the oriented crystalline resin tends to be low whereas the glass transition temperature of the amorphous resin or the crystalline resin having a melting point lower by 20° C. or more than that of the oriented crystalline resin tends to be high. In such a case, depending on the selected resins, the stretching of the amorphous resin or the crystalline resin having a melting point lower by 20° C. or more than that of the oriented crystalline resin may be difficult at optimum film stretching temperatures to promote orientation and crystallization, possibly making it impossible to obtain a film having desired reflection performance. Here, if the thermoplastic resins used in the multilayer laminated structure have glass transition temperatures with a difference of 20° C. or less, it will be easy to ensure an Rp value of 30% or more by realizing sufficient orientation of the resin that need orientation.

Furthermore, this allows the oriented crystalline thermoplastic resin and the amorphous resin or the crystalline resin having a melting point lower by 20° C. or more than that of the oriented crystalline resin to undergo film formation at film stretching temperatures suitable for promoting orientation and crystallization, making it easy to achieve both a high transparency in the perpendicular direction to the film plane and high reflection performance in oblique directions to the film plane. It is more preferable that the difference in glass transition temperature between the layers A and the layers B is 15° C. or more, more preferably 5° C. or less. As the difference in glass transition temperature decreases, it becomes easier to set up good film stretching conditions and to realize high optical performance.

For the film according to the present invention, it is preferable for the thermoplastic resin used in the layers B to have a structure derived from an alkylene glycol having a number average molecular weight of 200 or more. A higher aromatic content is preferred to increase the refractive index, as described above, and further inclusion of a structure derived from an alkylene glycol makes it easier to efficiently decrease the glass transition temperature while maintaining a desired refractive index, and as a result, this makes it easier to increase the in-plane average refractive index of each layer in the laminated film and to decrease their glass transition temperature.

Examples of the alkylene glycol include polyethylene glycol, polytrimethylene glycol, and polytetramethylene glycol. In addition, it is more preferable for the alkylene glycol to have a molecular weight of 200 or more, still more preferably 300 or more and 2,000 or less. In the case where the alkylene glycol has a molecular weight of less than 200, the alkylene glycol will not be incorporated sufficiently in the polymer due to its high volatility during the synthesis of the thermoplastic resin, possibly resulting in insufficient decrease in the glass transition temperature. On the other hand, if the molecular weight of the alkylene glycol is more than 2,000, it will not be suitable for film production because of decreased reactivity during the production of a thermoplastic resin.

For the film according to the present invention, furthermore, it is preferable for the thermoplastic resin used in the layers B to contain structures derived from two or more aromatic dicarboxylic acids and two or more alkylene diols and also contain a structure derived from an alkylene glycol having a number average molecular weight of at least 200 or more. It is necessary for the layers B to contain such structures so that they, in spite of being amorphous, have a refractive index that is nearly as high as the in-plane refractive index of the layers A, which are formed of an oriented crystalline resin, and also that they show a glass transition temperature that enables co-stretching with a crystalline thermoplastic resin. It is difficult to satisfy all these requirements simultaneously by using only one dicarboxylic acid and one alkylene diol. In the present case where two or more aromatic dicarboxylic acids and two or more alkylene diols are contained, the aromatic dicarboxylic acids ensures a high refractive index and the plurality of alkylene diols ensures a low glass transition temperature. In addition, the inclusion of a total of four or more dicarboxylic acids and diols serves to achieve a high degree of amorphousness.

For P-waves that are in the wavelength range of 400 nm to 700 nm and incident at an angle of 70° to the normal to the film plane, the film according to the present invention preferably has a reflectance of 30% or more, more preferably 50% or more, and still more preferably 70% or more. Being able to reflect beams in the visible range of 400 nm to 700 nm, the film shows high light condensing performance and achieves a high luminance when using a white light source. Furthermore, the film according to embodiments of the present invention undergoes a shift of the reflection wavelength range toward lower wavelengths as the incidence angle increases. Accordingly, since the film has a reflectance of 30% or more for P-waves that are in the wavelength range of 400 nm to 700 nm and incident at an angle of 70° to the normal to the film plane, it will have an adequate reflectance for beams that are in the wavelength range of 450 nm to 650 nm, which coincides the emission band of the light source, and incident even at angles of 70° or more.

It is also preferable for the ratio of Rp70/Rs70, where Rp70 represents the average reflectance over the wavelength range of 450 nm to 650 nm for P-waves incident at an angle of 70° to the normal to the film plane and Rs70 represents the average reflectance over the wavelength range of 450 nm to 650 nm for S-waves incident at an angle of 70° to the normal to the film plane, to be 1 or more, more preferably 1.2 or more, and still more preferably 1.5 or more. A higher reflectance for P-waves incident at an angle of 70° allows the film according to embodiments of the present invention to show higher light condensing performance and achieves a higher luminance. It is also preferable for the ratio of Rp40/Rs40, where Rp40 represents the average reflectance over the wavelength range of 450 nm to 650 nm for P-waves incident at an angle of 40° to the normal to the film plane and Rs40 represents the average reflectance over the wavelength range of 450 nm to 650 nm for S-waves incident at an angle of 40° to the normal to the film plane, to be 1 or more, more preferably 1.2 or more, and still more preferably 1.5 or more.

Good methods to control the reflectance over an intended wavelength range include the adjustment of the difference in through-plane refractive index between the layers A and the layers B, number of stacked layers, layer thickness distribution, film formation conditions (for example, stretching ratio, stretching speed, stretching temperature, heat treatment temperature, and heat treatment time). Regarding the constitution of the layers A and the layers B, it is preferable that the layers A are formed of a crystalline thermoplastic resin whereas the layers B are formed of a resin containing an amorphous thermoplastic resin as main component. Here, the expression “a resin containing an amorphous thermoplastic resin as main component” means that the amorphous thermoplastic resin accounts for 70% or more by weight. To increase the reflectance and decrease the necessary number of stacked layers, a larger difference in through-plane refractive index between the layers A and the layers B is more desirable, and the number of layers is preferably 101 or more, more preferably 401 or more, and still more preferably 601 or more, whereas the upper limit is about 5,000 in view of the need for a large-type lamination apparatus. To ensure a good layer thickness distribution, the optical thicknesses of the layers A and the layers B preferably meet the equation (a) given below.

[Mathematical formula 1]

λ=2(n_{A}d_{A}+n_{B}d_{B}) (A)

Here, A is the reflection wavelength; n_{A} is the through-plane refractive index of the layers A; d_{A} is the thickness of the layers A; n_{B} is the through-plane refractive index of the layers B, and d_{B} is the thickness of the layers B.

Regarding the layer thickness distribution, it is preferable for the layer thickness to be constant from one side of the film to the opposite side, increase or decrease from one side of the film to the opposite side, increase from one side of the film toward the film center and then decrease, or decrease from one side of the film toward the film center and then increase. Regarding the way of change in layer thickness distribution, it is preferable that the layer thickness changes continuously such as linearly, geometrically, or in a difference sequence manner, or that the film consists of groups of layers, each containing 10 to 50 layers that have substantially the same layer thickness, that differ stepwise in layer thickness.

As a good method, a layer with a thickness of 3 μm or more may be formed as a protection layer on each surface of the multilayer laminated film. It is preferable for these protection layers to have a thickness of 5 μm or more, more preferably 10 μm or more. Thicker protection layers can serve more effectively to prevent the formation of flow marks during film production, reduce the deformation of thin layers in the multilayer laminated film during or after lamination with other films or moldings, and increase the pressure resistance of the film. The thickness of the multilayer laminated film is not particularly limited, but for example, it is preferably 20 μm to 300 μm. If it is less than 20 μm, the film may decrease in bending strength, possibly leading to poor handleability. If it is more than 300 μm, on the other hand, the film may have excessively large bending strength, possibly leading to poor moldability.

It is necessary for the film according to embodiments of the present invention to have an average transmittance of 70% or more over a wavelength range of 450 nm to 650 nm for beams incident at an angle of 0° to the normal to the film plane. It is more preferably 85% or more, still more preferably 90% or more. A higher transmittance for beams incident at an angle of 0° to the normal to the film plane is more preferable because the film according to embodiments of the present invention will serve more effectively for condensing light. Preferred methods to increase the transmittance for beams incident perpendicularly to the film plane include decreasing the difference in in-plane refractive index between the layers A and the layers B and providing a primer layer, hard coat layer, or antireflection layer on the film surface. The existence of a layer having a lower refractive index than the surface resin of the film serves to increase its transmittance for beams incident perpendicularly to the film plane.

The film according to the present invention may have functional layers such as primer layer, hard coat layer, abrasion resistant layer, flaw prevention layer, antireflection layer, color correction layer, ultraviolet ray absorption layer, hindered amine light stabilization (HALS) layer, heat absorption layer, printing layer, gas barrier layer, and sticking layer, that are formed on the film surface. These layers may be provided singly or in combination, or a single layer may have a plurality of functions. It may also be good to add additives such as ultraviolet absorber, hindered amine light stabilizer (HALS), heat absorbent, crystal nucleating agent, and plasticizer to the multilayer laminated film.

It is preferable for the film according to the present invention to have a phase difference of 2,000 nm or less. To increase the transmittance for beams incident perpendicularly to the film plane, it is necessary to decrease the difference in refractive index in a parallel direction to the film plane between the layers of two thermoplastic resins in the final product. If there is anisotropic difference in orientation between the width direction of the film and the flow direction, which is perpendicular to the width direction, selection of resins so as to ensure a small difference in refractive index in either direction will lead to a large refractive index in the perpendicular direction. As a result, it may be sometimes difficult to realize transparency in the perpendicular direction to the film plane. In such a case, if the phase difference, which is a parameter of the anisotropy in orientation, is maintained at 2,000 nm or less, it works to decrease the anisotropy in orientation in the film plane, thus serving to easily realize a transmittance of 70% or more for beams incident perpendicularly to the film plane. The phase difference is preferably 1,000 nm or less, more preferably 500 nm or less. As the phase difference decreases, the difference in refractive index in a parallel direction to the film plane between the two thermoplastic resins will be easier to decrease in both the width direction and the flow direction, which is perpendicular thereto, making it possible to increase the transmittance for beams incident perpendicularly to the film plane. It also serves to produce liquid crystal displays free of significant iridescent color unevenness.

Specific examples of production of the film according to the present invention will be described below, but the invention should not be construed as being limited to these examples. In the case where the film according to embodiments of the present invention has a multilayer laminated film structure as described above, such a laminated structure containing there or more layers can be produced by the method described below. Thermoplastic resins are supplied from two extruders, i.e., one for layers A and the other for layers B, and the polymers are fed through flow channels to a generally known lamination apparatus, for example a combination of a multimanifold type feedblock and a square mixer or a stand-alone comb type feedblock, to form a stack of three or more layers.

Subsequently, as a typical procedure, it is melted and melt-extruded through a T-die etc. into a sheet and then cooled and solidified on a casting drum to form an unstretched multilayer laminated film. To ensure an increased accuracy in lamination of the layers A and the layers B, it is desirable to adopt a method as described in Japanese Unexamined Patent Publication (Kokai) No. 2007-307893, Japanese Patent No. 4691910, or Japanese Patent No. 4816419. If necessary, furthermore, it may also be good to dry the thermoplastic resin to be used as the layers A and the thermoplastic resin to be used as the layers B.

Then, this unstretched multilayer laminated film is stretched and heat-treated. It is preferable that it is biaxially stretched by an appropriate stretching method such as the generally known sequential biaxial stretching method or simultaneous biaxial stretching method. Stretching is preferably performed in the temperature range not lower than the glass transition temperature of the unstretched laminated film and not higher than the temperature higher by 80° C. than that glass transition temperature. The stretching ratio is preferably in the range of 2 to 8, more preferably 3 to 6, in both the length direction and the width direction, and the difference in stretching ratio between the length direction and the width direction is preferably small.

Stretching in the length direction is preferably carried out by means of a change in speed between the rolls of the longitudinal stretching machine. Stretching in the width direction, on the other hand, is performed by using the generally known tenter method. Specifically, the film is conveyed with both ends held by clips and it is stretched in the width direction by widening the distance between the clips. It is also preferable to perform simultaneous biaxial stretching in a tenter.

A procedure for performing simultaneous biaxial stretching is described below. An unstretched film cast on a cooling roller is then introduced into a simultaneous biaxial stretching tenter, where the film is conveyed with both ends held by clips to undergo simultaneous and/or stepwise stretching in the length direction and the width direction. Stretching in the length direction is carried out by increasing the intervals of the clips in the tenter while stretching in the width direction is carried out by increasing the distance between the rails on which the clips travels. The tenter clips used in the stretching and heat treatment steps for the present invention are preferably driven by linear motors. Other devices using pantographs, screws, etc., are available, but the use of linear motors is preferred because they allow the clips to have a high degree of freedom so that the stretching ratio can be changed as desired.

It is also preferable to perform heat treatment after the stretching step. Heat treatment is preferably performed in the temperature range not lower than the stretching temperature and not higher than the temperature lower by 10° C. than the melting point of the thermoplastic resin in the layers A, and it is also preferable to perform, after the heat treatment step, a cooling step in the range not higher than the temperature lower by 30° C. than the heat treatment temperature. In addition, it is also preferable to shrink (relax) the film in the width direction and/or the length direction in the heat treatment step or the cooling step in order to decrease the thermal shrinkage rate of the film. The relaxation rate is preferably in the range of 1% to 10%, more preferably in the range of 1% to 5%. Finally, the film is wound up by a winder to provide the film according to the present invention.

### EXAMPLES

The film according to the present invention is described below with reference to specific examples. It is noted that even when a thermoplastic resin other than the thermoplastic resins specifically cited below is adopted, a film according to the present invention is likely to be obtained by following the explanation given in the Examples or other parts of this Description.

### [Methods for Measurement of Properties and Methods for Evaluation of Effects]

The methods for evaluation of properties and the methods for evaluation of effects used here are as described below.

### (1) Direction of Main Orientation Axis

A specimen with a sampling size of 10 cm×10 cm was cut out from the widthwise center of a film. The direction of the main orientation axis is determined by using a molecular orientation analyzer (MOA-2001, manufactured by KS Systems Inc. (currently Oji Scientific Instruments Co., Ltd.)).

### (2) Average Transmittance Over 450 nm to 650 nm

Using a spectrophotometer (U-4100 Spectrophotomater, manufactured by Hitachi, Ltd.) in the normal mode (solid measurement system), transmittance for light incident at an incidence angle (ϕ) of 0° was measured at 1 nm intervals over the wavelength range of 450 nm to 1,600 nm to determine the average transmittance over the range of 450 nm to 650 nm and the minimum transmittance in the wavelength range of 800 nm to 1,600 nm. The measuring conditions included a slit of 2 nm (visible), automatic control (infrared), a gain of 2, and a scanning speed of 600 nm/min.

### (3) Maximum Parallel Light Transmittance in the Range of 800 nm to 1,600 nm

Using a spectrophotometer (U-4100 Spectrophotomater, manufactured by Hitachi, Ltd.) equipped with an accessory angle variable type reflection unit and a Glan Laser polarizer, transmittance for light incident at an incidence angle (ϕ) of 0° was measured at 1 nm intervals over the wavelength range of 800 nm to 1,600 nm was measured to determine the maximum. Here, measurement was performed for beams incident at each of the two surfaces (for convenience referred to as side A and side B) of a sample. The sample was located 14 cm from the inlet of the integrating sphere.

### (4) Reflectance

Using a spectrophotometer (U-4100 Spectrophotomater, manufactured by Hitachi, Ltd.) equipped with an accessory angle variable type reflection unit and a Glan Laser polarizer, transmittance was measured for P-wave and S-wave incident at an incidence angle (p) of 20°, 40°, or 70° was measured at 1 nm intervals over the wavelength range of 400 nm to 700 nm. The reflectance measurements taken above were examined to determine the average reflectance over the wavelength range of 450 nm to 650 nm for P-waves and S-waves incident at an angle of 20°, 40°, or 70°, which is denoted as Rp20, Rp40, or Rp70 and Rs20, Rs40, or Rs70, respectively, followed by calculating the values of Rp40/Rs40 and Rp70/Rs70. Here, the 20°, 40°, or 70° inclination direction was coincident with the direction of the main orientation axis of the film.

### (5) Glass Transition Temperature and Melting Point

A 5 mg portion of resin pellets was weighed out on an electronic balance and sandwiched between aluminum packing sheets to prepare a specimen and it was placed in a differential scanning calorimeter (Robot DSC-RDC220, manufactured by Seiko Instruments Inc.) and heated from 25° C. to 300° C. at 20° C./min for measurement according to JIS-K-7122 (1987). Data analysis was performed by using Disk Session SSC/5200 of Seiko Instruments Inc. From the resulting DSC data, the glass transition temperature (Tg) and melting point (Tm) were determined.

### (6) Refractive Index

Resin pellets vacuum-dried at 70° C. for 48 hours were melted at 280° C. and pressed in a press machine, followed by quenching to prepare a sheet with a thickness of 500 μm. The refractive index of the sheet was measured using an Abbe refractometer (NAR-4T, manufactured by Atago Co., Ltd.) and a NaD lamp.

### (7) Measuring Method for IV (Intrinsic Viscosity)

Orthochlorophenol was used as solvent and a sample was dissolved by heating at temperature 100° C. for 20 minutes. Then, the viscosity of the solution was measured using an Ostwald viscometer at a temperature of 25° C., followed by calculating the intrinsic viscosity.

### (8) Phase Difference

A KOBRA-21ADH phase difference measuring apparatus manufactured by Oji Scientific Instruments Co., Ltd. was used. A sample having a size of 3.5 cm×3.5 cm was cut out and mounted in the apparatus and its retardation for light having a wavelength 590 nm and incident at an angle of 0° was measured.

### (9) Measurement of Emission Band of Light Source

Light from a light source was examined using a small type spectrophotometer (C10083MMD, manufactured by Hamamatsu Photonics K.K.) provided with NA0.22 optical fiber. To determine the emission band of a light source, the 350 nm to 800 nm part of the emission spectrum obtained was examined to identify the wavelength at which a maximum intensity, which is referred to as the emission peak wavelength of the light source, and the wavelength range defined by the shortest wavelength and the longest wavelength where the emission intensity was 5% or more of that at the emission peak wavelength was adopted.

### (10) Measurement of Luminance

A light source unit containing either of the two backlight members was used.

Backlight 1: 32 inch, white LED, edge type backlight, light source emission band 425 nm to 652 nm
Backlight 2: 43 inch, white LED, direct type backlight, light source emission band 418 nm to 658 nm
Luminance was measured at light receiving angles of +70°, −70°, and 0° using a BM-7 instrument manufactured by Topcon Corporation and an angle variation unit. The average of the measurements taken at +70° and −70° was adopted as the luminance at 70°. The azimuthal angle of the inclination to a light receiving angle of 70° was coincident with the length direction of the backlight member, and the luminance values La(0°) and La(70°) of beams incident at an angle of 0° and 70°, respectively, to the normal to the film according to embodiments of the present invention and the luminance values Lb(0°) and Lb(70°) of beams emitted at an angle of 0° and 70°, respectively, to the normal to the film according to embodiments of the present invention were applied to the formula (1) and formula (2). In addition, the azimuthal angle of the length direction of the backlight member is defined as 0°, and measurements at an inclination angle of 70° were taken at azimuthal angles of 45°, 90°, and 135° clockwise, followed by calculating the difference between the maximum and the minimum of the luminance Lb(70°)/La(70°).

### (Resin Used as Film Material)

Resin A: a copolymer of polyethylene terephthalate with IV of 0.67 (polyethylene terephthalate copolymerized with an isophthalic acid component, which accounts for 10 mol % of the total acid component quantity). Refractive index 1.57, Tg 75° C., and Tm 230° C.

Resin B: polyethylene terephthalate with IV of 0.65. Refractive index 1.58, Tg 78° C., and Tm 254° C.

Resin C: a polyester prepared by blending a copolymer of polyethylene terephthalate with IV of 0.67 (polyethylene terephthalate copolymerized with a 2,6-naphthalene dicarboxylic acid component, which accounts for 60 mol % of all acid components) with an aromatic ester containing terephthalic acid, butylene group, and ethylhexyl group and having a number average molecular weight of 2,000, which accounts for 10 wt % of the total resin weight. Refractive index 1.62 and Tg 90° C.

Resin D: a copolymer of polyethylene naphthalate with IV of 0.64 (polyethylene naphthalate copolymerized with a 2,6-naphthalene dicarboxylic acid component, which accounts for 80 mol % of all acid components, an isophthalic acid component, which accounts for 20 mol % of all acid components, and a polyethylene glycol with a molecular weight of 400, which accounts for 5 mol % of all diol components). Tg 85° C. and Tm 215° C.

Resin E: a copolymer of polyethylene terephthalate with IV of 0.73 (polyethylene terephthalate copolymerized with a cyclohexane dimethanol component, which accounts for 33 mol % of the all diol components). Refractive index 1.57 and Tg 80° C.

### Example 1

Resin A was used as the thermoplastic resin to form the layers A, and Resin C was used as the thermoplastic resin to form the layers B. Resin A and Resin C were melted at 280° C. in separate extruders, filtered through five FSS type leaf disk filters, and laminated by the method described in Japanese Unexamined Patent Publication (Kokai) No. 2007-307893 while weighing in gear pumps to adjust the discharging ratio (lamination ratio) Resin A/Resin C to 1.3. Their layers were stacked alternately in a 493-layered feedblock (247 for layers A and 246 for layers B) designed to produce a film having a reflection wavelength range of 400 nm to 600 nm for P-waves incident at an angle of 70°. Then, the layers were supplied to a T-die where they were molded into a sheet, and while applying an electrostatic voltage of 8 kv from a wire, it was quenched for solidification on a casting drum having a surface temperature maintained at 25° C. to produce a an unstretched multilayer laminated film. This unstretched film was subjected to longitudinal stretching at 95° C. to a stretching ratio of 3.6, and both surfaces of the film were subjected to corona discharge treatment in air, followed by coating both treated surfaces of the film with a lamination forming liquid consisting of a polyester resin with a glass transition temperature of 18° C., a polyester resin with a glass transition temperature of 82° C., and silica particles with an average particle diameter of 100 nm. Subsequently, the film was introduced into a tenter with both ends held by clips and subjected to lateral stretching at 110° C. to a ratio of 3.7, followed by heat treatment at 210° C., 5% relaxation in the width direction, and cooling at 100° C. to provide a multilayer laminated film with a thickness of 60 μm. Physical properties of the resulting film are shown in Table 1.

### Example 2

Resin A was used as the thermoplastic resin to form the layers A, and Resin C was used as the thermoplastic resin to form the layers B. Resin A and Resin C were melted at 280° C. in separate extruders, filtered through five FSS type leaf disk filters, and laminated by the method described in Japanese Unexamined Patent Publication (Kokai) No. 2007-307893 while weighing in gear pumps to adjust the discharging ratio (lamination ratio) Resin A/Resin C to 1.5. Their layers were stacked alternately in a 801-layered feedblock (401 for layers A and 400 for layers B) designed to produce a film having a reflection wavelength range of 400 nm to 1,000 nm for P-waves incident at an angle of 70°. Then, the layers were supplied to a T-die where they were molded into a sheet, and while applying an electrostatic voltage of 8 kv from a wire, it was quenched for solidification on a casting drum having a surface temperature maintained at 25° C. to produce a an unstretched multilayered film. This unstretched film was subjected to longitudinal stretching at 95° C. to a stretching ratio of 3.6, and both surfaces of the film were subjected to corona discharge treatment in air, followed by coating both treated surfaces of the film with a lamination forming liquid consisting of a polyester resin with a glass transition temperature of 18° C., a polyester resin with a glass transition temperature of 82° C., and silica particles with an average particle diameter of 100 nm. Subsequently, the film was introduced into a tenter with both ends held by clips and subjected to lateral stretching at 110° C. to a ratio of 3.7, followed by heat treatment at 210° C., 5% relaxation in the width direction, and cooling at 100° C. to provide a multilayered laminated film with a thickness of 110 μm. Physical properties of the resulting film are shown in Table 1.

### Example 3

Resin B was used as the thermoplastic resin to form the layers A, and Resin D was used as the thermoplastic resin to form the layers B. Resin B and Resin D were melted at 280° C. in separate extruders, filtered through five FSS type leaf disk filters, and laminated by the method described in Japanese Unexamined Patent Publication (Kokai) No. 2007-307893 while weighing in gear pumps to adjust the discharging ratio (lamination ratio) Resin B/Resin D to 1.3. Their layers were stacked alternately in a 493-layered feedblock (247 for layers A and 246 for layers B) designed to produce a film having a reflection wavelength range of 400 nm to 600 nm for P-waves incident at an angle of 70°. Then, the layers were supplied to a T-die where they were molded into a sheet, and while applying an electrostatic voltage of 8 kv from a wire, it was quenched for solidification on a casting drum having a surface temperature maintained at 25° C. to produce a an unstretched multilayer laminated film. This unstretched film was subjected to longitudinal stretching at 90° C. to a stretching ratio of 3.3, and both surfaces of the film were subjected to corona discharge treatment in air, followed by coating both treated surfaces of the film with a lamination forming liquid consisting of a polyester resin with a glass transition temperature of 18° C., a polyester resin with a glass transition temperature of 82° C., and silica particles with an average particle diameter of 100 nm. Subsequently, the film was introduced into a tenter with both ends held by clips and subjected to lateral stretching at 100° C. to a ratio of 3.5, followed by heat treatment at 210° C., 5% relaxation in the width direction, and cooling at 100° C. to provide a multilayer laminated film with a thickness of 60 μm. Physical properties of the resulting film are shown in Table 1.

### Example 4

Resin B was used as the thermoplastic resin to form the layers A, and Resin D was used as the thermoplastic resin to form the layers B. Resin B and Resin D were melted at 280° C. in separate extruders, filtered through five FSS type leaf disk filters, and laminated by the method described in Japanese Unexamined Patent Publication (Kokai) No. 2007-307893 while weighing in gear pumps to adjust the discharging ratio (lamination ratio) Resin B/Resin D to 1.5. Their layers were stacked alternately in a 801-layered feedblock (401 for layers A and 400 for layers B) designed to produce a film having a reflection wavelength range of 400 nm to 1,000 nm for P-waves incident at an angle of 70°. Then, the layers were supplied to a T-die where they were molded into a sheet, and while applying an electrostatic voltage of 8 kv from a wire, it was quenched for solidification on a casting drum having a surface temperature maintained at 25° C. to produce a an unstretched multilayer laminated film. This unstretched film was subjected to longitudinal stretching at 90° C. to a stretching ratio of 3.3, and both surfaces of the film were subjected to corona discharge treatment in air, followed by coating both treated surfaces of the film with a lamination forming liquid consisting of a polyester resin with a glass transition temperature of 18° C., a polyester resin with a glass transition temperature of 82° C., and silica particles with an average particle diameter of 100 nm. Subsequently, the film was introduced into a tenter with both ends held by clips and subjected to lateral stretching at 100° C. to a ratio of 3.5, followed by heat treatment at 210° C., 5% relaxation in the width direction, and cooling at 100° C. to provide a multilayered laminated film with a thickness of 110 μm. Physical properties of the resulting film are shown in Table 1.

### Example 5

Two multilayer laminated films were prepared as in Example 4 and combined by a laminator using an acrylic optical adhesive with a thickness of 25 μm. Physical properties of the resulting film are shown in Table 1.

### Comparative Example 1

Resin B was used as thermoplastic resin. It was melted at 280° C. in an extruder, filtered through five FSS type leaf disk filters, and supplied to a T-die where it was molded into a sheet, and while applying an electrostatic voltage of 8 kv from a wire, it was quenched for solidification on a casting drum having a surface temperature maintained at 25° C. to produce a an unstretched film. This unstretched film was subjected to longitudinal stretching at 90° C. to a stretching ratio of 3.3, and both surfaces of the film were subjected to corona discharge treatment in air, followed by coating both treated surfaces of the film with a lamination forming liquid consisting of a polyester resin with a glass transition temperature of 18° C., a polyester resin with a glass transition temperature of 82° C., and silica particles with an average particle diameter of 100 nm. Subsequently, the film was introduced into a tenter with both ends held by clips and subjected to lateral stretching at 100° C. to a ratio of 3.5, followed by heat treatment at 210° C., 5% relaxation in the width direction, and cooling at 100° C. to provide a film with a thickness of 50 μm. Physical properties of the resulting film are shown in Table 1.

### Comparative Example 2

Except for using Resin E as the thermoplastic resin to form the layers B, the same procedure as in Example 4 was carried out to produce a multilayer laminated film with a thickness of 110 μm. Physical properties of the resulting film are shown in Table 1.

### Comparative Example 3

A prism sheet prepared by forming a prism layer having an apex angle of 90° and apex intervals of 50 μm over one side of a polyethylene terephthalate film of 100 μm, and the maximum parallel light transmittance of the polyethylene terephthalate film surface (side A) and that of the prism layer surface (side B) were measured over the wavelength range of 800 nm to 1,600 nm. The maximum transmittance was 0% for both beams incident to the side A and the side B. If this prism sheet is applied to a display device having an infrared sensor, therefore, the detection accuracy of the infrared sensor will deteriorate considerably.

### (Evaluation of Luminance of Light Source Unit)

### Examples 6 to 8 and Comparative Examples 4 to 6

Luminance was measured using a 32-inch edge type white LED backlight (backlight 1). Conventional edge type backlights (a light source is located on the edge of a light guide plate) consisting of (1) a white reflection film and a light guide plate, (2) a white reflection film, a light guide plate, and a diffusing sheet, or (3) a white reflection film, a light guide plate, a diffusing sheet, and a prism sheet were constructed, and films produced as in Example 1, Example 4, Example 5, Comparative example 1, and Comparative example 2 were disposed at the positions specified in Table 2. For each of the resulting light source units, the overall front luminance, the luminance for light incident to the film, and the luminance for light emitted from the film were measured. Table 2 shows the structures of the backlights, the positions of the films, and the measured front luminance values (the relative frontward luminance in the Table means the relative front luminance in comparison with the luminance (100%) of a film-free backlight having a conventional structure). As seen from Table 2, the light source units containing the film according to embodiments of the present invention are higher in front luminance than the backlights having conventional structures and those containing conventional films.

### Example 9 and Comparative Example 7

Luminance was measured using a 32-inch direct type white LED backlight (backlight 2). A conventional direct type backlight (containing a substrate, light source pieces mounted thereon, and white reflection film with holes at positions of the light source pieces laid on the substrate) having the structure of (1) a white reflection film and a light guide plate was used as light source, and films produced as in Example 1, Example 4, Example 5, Comparative example 1, and Comparative example 2 were disposed at the positions specified in Table 3. For each of the resulting light source units, the overall front luminance, the luminance for light incident to the film, and the luminance for light emitted from the film were measured. Table 3 shows the structures of the backlights, the positions of the films, and the measured front luminance values (the relative frontward luminance in the Table means the relative front luminance in comparison with the luminance (100%) of a film-free backlight having a conventional structure).

TABLE 1

| | | | | | | | | | | Average | | | |
|---|---|---|---|---|---|---|---|---|---|---|---|---|---|
| | | | | | Maximum parallel | | | | | reflectance | | | |
| | | | | | light | | | | | over 400 | | | |
| | | | | Average | transmittance | | | | | nm to 700 | | | |
| | | | | transmittance | over wavelength | | | | | nm for | | | |
| | | | | over | range of 800 | | | | | P-wave | | | |
| | | | | wavelength | nm to 1,600 nm | | P-wave | | | incident | | | |
| | Resin in | Resin in | Number | range of 450 | incident | incident | reflectance | | | at angle | Rp70/ | Rp40/ | Phase |
| | layer A | layer B | of layers | nm to 650 nm | to side A | to side B | Rp20 | Rp40 | Rp70 | of 70° | Rs70 | Rs40 | difference |
| | (—) | (—) | (—) | (%) | (%) | (%) | (%) | (%) | (%) | (%) | (—) | (—) | (nm) |
| Example 1 | resin A | resin C | 491 | 89 | 87 | 87 | 11 | 21 | 51 | 39 | 1.0 | 1.1 | 320 |
| Example 2 | resin A | resin C | 801 | 89 | 86 | 86 | 12 | 17 | 50 | 47 | 1.1 | 0.9 | 589 |
| Example 3 | resin B | resin D | 491 | 91 | 89 | 89 | 9 | 21 | 60 | 46 | 1.2 | 1.3 | 190 |
| Example 4 | resin B | resin D | 801 | 91 | 89 | 89 | 9 | 18 | 62 | 59 | 1.3 | 1.0 | 354 |
| Example 5 | resin B | resin D | 1601 | 89 | 87 | 87 | 11 | 28 | 73 | 71 | 1.5 | 1.6 | 676 |
| Comparative | resin B | — | 1 | 92 | 88 | 88 | 7 | 3 | 9 | 9 | 0.2 | 0.2 | 892 |
| example 1 | | | | | | | | | | | | | |
| Comparative | resin B | resin E | 801 | 48 | 85 | 85 | 54 | 63 | 83 | 80 | 1.0 | 1.0 | 593 |
| example 2 | | | | | | | | | | | | | |
| Comparative | — | — | — | — | 0 | 0 | — | — | — | — | — | — | — |
| example 3 | | | | | | | | | | | | | |

TABLE 2

| | | | Relative | | | |
|---|---|---|---|---|---|---|
| | Film used | | luminance | | | Azimuthal |
| | in light | | in front | | | variation in |
| | source unit | Constitution | (%) | Lb(0°)/La(0°) | Lb(70°)/La(70°) | Lb(70°)/La(70°) |
| Example 6-1 | Example 1 | white reflection film/light guide plate/ | 128 | 1.28 | 0.71 | 0.10 |
| | | film of Example 1 | | | | |
| Example 6-2 | Example 4 | white reflection film/light guide plate/ | 135 | 1.35 | 0.65 | 0.08 |
| | | film of Example 4 | | | | |
| Example 6-3 | Example 5 | white reflection film/light guide plate/ | 140 | 1.40 | 0.63 | 0.07 |
| | | film of Example 5 | | | | |
| Comparative | film-free | white reflection film/light guide plate | 100 | — | — | — |
| example 4-1 | (conventional | | | | | |
| | constitution) | | | | | |
| Comparative | Comparative | white reflection film/light guide plate/ | 110 | 1.10 | 0.97 | 0.00 |
| example 4-2 | example 1 | film of Comparative example 1 | | | | |
| Comparative | Comparative | white reflection film/light guide plate/ | 125 | 1.25 | 0.68 | 0.18 |
| example 4-3 | example 2 | film of Comparative example 2 | | | | |
| Example 7-1 | Example 1 | white reflection film/light guide plate/ | 107 | 1.07 | 0.68 | 0.03 |
| | | diffusing sheet/film of Example 1 | | | | |
| Example 7-2 | Example 4 | white reflection film/light guide plate/ | 111 | 1.11 | 0.63 | 0.02 |
| | | diffusing sheet/film of Example 4 | | | | |
| Example 7-3 | Example 5 | white reflection film/light guide plate/ | 115 | 1.15 | 0.61 | 0.02 |
| | | diffusing sheet/film of Example 5 | | | | |
| Comparative | film-free | white reflection film/light guide plate/ | 100 | — | — | — |
| example 5-1 | (conventional | diffusing sheet | | | | |
| | constitution) | | | | | |
| Comparative | Comparative | white reflection film/light guide plate/ | 100 | 1.00 | 0.97 | 0.00 |
| example 5-2 | example 1 | diffusing sheet/film of Comparative example 1 | | | | |
| Comparative | Comparative | white reflection film/light guide plate/ | 95 | 0.95 | 0.84 | 0.11 |
| example 5-3 | example 2 | diffusing sheet/film of Comparative example 2 | | | | |
| Example 8-1 | Example 1 | white reflection film/light guide plate/ | 102 | 1.07 | 0.68 | 0.03 |
| | | diffusing sheet/film of Example 1/prism sheet | | | | |
| Example 8-2 | Example 4 | white reflection film/light guide plate/ | 104 | 1.11 | 0.63 | 0.02 |
| | | diffusing sheet/film of Example 4/prism sheet | | | | |
| Example 8-3 | Example 5 | white reflection film/light guide plate/ | 107 | 1.15 | 0.61 | 0.02 |
| | | diffusing sheet/film of Example 5/prism sheet | | | | |
| Comparative | film-free | white reflection film/light guide plate/ | 100 | — | — | — |
| example 6-1 | (conventional | diffusing sheet/prism sheet | | | | |
| | constitution) | | | | | |
| Comparative | Comparative | white reflection film/light guide plate/ | 99 | 1.00 | 0.97 | 0.00 |
| example 6-2 | example 1 | diffusing sheet/film of Comparative | | | | |
| | | example 1/prism sheet | | | | |
| Comparative | Comparative | white reflection film/light guide plate/ | 83 | 0.95 | 0.84 | 0.11 |
| example 6-3 | example 2 | diffusing sheet/film of Comparative | | | | |
| | | example 2/prism sheet | | | | |
| Example 9-1 | film of | white reflection film/diffusion plate/ | 121 | 1.21 | 0.72 | 0.03 |
| | Example 1 | film of Example 1 | | | | |
| Example 9-2 | film of | white reflection film/diffusion plate/ | 127 | 1.27 | 0.66 | 0.01 |
| | Example 4 | film of Example 4 | | | | |
| Example 9-3 | film of | white reflection film/diffusion plate/ | 136 | 1.36 | 0.62 | 0.02 |
| | Example 5 | film of Example 5 | | | | |
| Comparative | film-free | white reflection film/diffusing plate | 100 | — | — | — |
| example 7-1 | (conventional | | | | | |
| | constitution) | | | | | |
| Comparative | film of | white reflection film/diffusing plate/ | 95 | 0.95 | 0.90 | 0.00 |
| example 7-2 | Comparative | film of Comparative example 1 | | | | |
| | example 1 | | | | | |
| Comparative | film of | white reflection film/diffusing plate/ | 78 | 0.78 | 0.52 | 0.09 |
| example 7-3 | Comparative | film of Comparative example 2 | | | | |
| | example 2 | | | | | |

The present invention relates to a light source unit, a display device, and a film having increased front luminance in comparison with the conventional ones.

### EXPLANATION OF NUMERALS

1: S-wave reflectance
2: P-wave reflectance
3: light guide plate
4: light emitting surface of the light guide plate
5: opposite surface to the light emitting surface of the light guide plate
6a: a beam reflected and radiated upward in oblique directions above the plane in the light guide plate
6b: a beam reflected by the light emitting surface of the light guide plate
6c: a beam emitted out of the light guide plate
6d: specular reflection component of light reflected by the opposite surface to the light emitting surface of the light guide plate
7a: a beam reflected and radiated upward in oblique directions above the plane in the light guide plate
7b: a beam reflected by the light emitting surface of the light guide plate
7d: specular reflection component of light reflected by the opposite surface to the light emitting surface of the light guide plate
8: frontward one of diffuse reflection components of light reflected by the opposite surface to the light emitting surface of the light guide plate
9: frontward one of diffuse reflection components of light reflected by the opposite surface to the light emitting surface of the light guide plate
10b: a beam reflected by the film according to embodiments of the present invention
10d: specular reflection component of light reflected by the opposite surface to the light emitting surface of the light guide plate
11: frontward one of diffuse reflection components of light reflected by the opposite surface to the light emitting surface of the light guide plate
12: the film according to embodiments of the present invention
13: light source unit

1. A light source unit comprising a light source and a film, wherein:
the light source has an emission band in the wavelength range of 450 nm to 650 nm, and the film has an average transmittance of 70% or more for incident beams in the wavelength range of 450 nm to 650 nm coming from the light source at an angle of 0° to the normal to the film plane;
the P-waves of incident beams coming from the light source at an angle of 20°, 40°, or 70° to the normal to the film plane satisfy the relation of Rp20≤Rp40<Rp70 where Rp20, Rp40, and Rp70 represent their average reflectance (%) over the wavelength range of 450 nm to 650 nm, with Rp70 being 30% or more; and
the relations represented by the following formulae (1) and (2) are satisfied where La(0°) is the luminance of an incident beam coming from the light source at an angle of 0° to the normal to the film plane, La(70°) is the luminance of an incident beam at an angle of 70° to the normal to the film plane, Lb(0°) is the luminance of a beam emitted from the film at an angle of 0° to the normal to the film plane after coming from the light source and entering the film, and Lb(70°) is the luminance of a beam emitted from the film at an angle of 70° to the normal to the film plane:
Lb(0°)/La(0°)≥0.8 (1)
Lb(70°)/La(70°)<1.0 (2)

2. A light source unit as set forth in claim 1, wherein the azimuthal variation in the Lb(70°)/La(70°) ratio is 0.3 or less.

3. A light source unit as set forth in either claim 1, wherein the film has a maximum parallel light transmittance of 50% or more for beams having a wavelength of 800 nm to 1,600 nm and an incidence angle of 0° to the normal to the film plane.

4. A light source unit as set forth in claim 1, having a light guide plate, with the film being disposed on the light emitting surface of the light guide plate.

5. A light source unit as set forth in claim 1, having a substrate carrying a plurality of light sources, with the film being disposed on the light emitting surface of the substrate.

6. A display apparatus comprising a light source unit as set forth in claim 1.

7. A display apparatus comprising a light source unit as set forth in claim 1, having a structure containing a diffusing sheet, a prism sheet, and a polarization reflection film stacked in this order, with the film being disposed between the diffusing sheet and the polarization reflection film.

8. A display apparatus as set forth in claim 7, having a structure containing a reflection film, a light guide plate, a diffusing sheet, a prism sheet, and a polarization reflection film stacked in this order.

9. A display apparatus as set forth in claim 7, having a structure containing a reflection film, a light source, a diffusing sheet, a prism sheet, and a polarization reflection film stacked in this order.

10. A display apparatus as set forth in claim 6, comprising a infrared sensor.

11. A display apparatus as set forth in claim 6, comprising a view angle control layer.

12. A film designed for use in a display apparatus, having an average transmittance of 70% or more for incident beams in the wavelength range of 450 nm to 650 nm coming at an angle of 0° to the normal to the film plane, wherein the P-waves of incident beams coming at an angle of 20°, 40°, or 70° to the normal to the film plane satisfy the relation of Rp20≤Rp40<Rp70 where Rp20, Rp40, and Rp70 represent their average reflectance (%) over the wavelength range of 450 nm to 650 nm, with Rp70 being 30% or more.

13. A film as set forth in claim 12, wherein the P-wave of a beam incident at an angle of 70° to the normal to the film plane has an average reflectance of 30% or more over the wavelength range of 400 nm to 700 nm.

14. A film as set forth in claim 12, wherein the ratio of Rp70/Rs70, where Rp70 represents the average reflectance over of 450 nm to 650 nm for P-waves incident at an angle of 70° to the normal to the film plane and Rs70 represents the average reflectance over the wavelength range of 450 nm to 650 nm for S-waves incident at an angle of 70° to the normal to the film plane, is 1 or more.

15. A film as set forth in claim 12, wherein the ratio of Rp40/Rs40, where Rp40 represents the average reflectance over the wavelength of 450 nm to 650 nm for P-waves incident at an angle of 40° to the normal to the film plane and Rs40 represents the average reflectance over the wavelength range of 450 nm to 650 nm for S-waves incident at an angle of 40° to the normal to the film plane, is 1 or more.

16. A film as set forth in claim 12, wherein the phase difference is 2,000 nm or less.

17. A film as set forth in claim 12, wherein a plurality of layers containing different thermoplastic resins are stacked alternately.

18. A film as set forth in claim 17, wherein the thermoplastic resin forming either type of layers (layers A) contains a crystalline polyester whereas the thermoplastic resin forming the other type of layers (layers B) contains either an amorphous polyester or a crystalline polyester having a melting point lower by 20° C. or more than that of the polyester of the layers A, with the difference in in-plane refractive index between the layers A and the layers B being 0.04 or less and the difference in glass transition temperature between them being 20° C. or less.

19. A film as set forth in claim 18, wherein the thermoplastic resin forming the layers B contains a structure derived from an alkylene glycol having a number average molecular weight of 200 or more.

20. A film as set forth in claim 18, wherein the thermoplastic resin forming the layers B contains structures derived from two or more aromatic dicarboxylic acids and two or more alkylene diols and also contain a structure derived from an alkylene glycol having a number average molecular weight of at least 200 or more.
